(19) United States
(12) Patent Application Publication
(10) Pub. No.: US 2018/0040910 A1
(43) Pub. Date: Feb. 8, 2018

(54) MANUFACTURE OF HIGH CAPACITY SOLID STATE BATTERIES

(71) Applicant: Sakti3, Inc.

(72) Inventors: Myoungdo CHUNG, Ann Arbor, MI (US); Hyon Cheol KIM, Ann Arbor, MI (US); Ann Marie SASTRY, Ann Arbor, MI (US); Xiangchun ZHANG, Ann Arbor, MI (US); Chia-Wei WANG, Ypsilanti, MI (US); Yen-Hung CHEN, Ann Arbor, MI (US)

(73) Assignee: Sakti3, Inc., Ann Arbor, MI (US)

(21) Appl. No.: 15/537,352

(22) PCT Filed: Dec. 17, 2015
(86) PCT No.: PCT/US2015/066525

§ 371 Date: Jun. 16, 2017

Related U.S. Application Data
(60) Provisional application No. 62/094,039, filed on Dec. 18, 2014.

(51) Int. Cl. H01M 10/04

(52) U.S. Cl. CPC H01M 10/04; H01M 2220/30

(57) ABSTRACT

Techniques related to the manufacture of electrochemical cells are disclosed in herein. Specifically, a method for manufacturing solid state batteries can include an iterative set of process sequences that can be repeated a number of times to build multiple stacks to achieve high capacity which is greater than 0.1 mAh.

### REFERENCE TO RELATED APPLICATIONS

This application is a national stage application under 37 USC 371 of International Application No. PCT/US2015/066525, filed Dec. 17, 2015, which claims the benefit of U.S. Provisional Application No. 62/094,039, filed Dec. 18, 2014, the entire contents of which are incorporated herein by reference.

### BACKGROUND OF THE INVENTION

This present invention relates to the manufacture of a high capacity solid-state electrochemical cell. More particularly, the present invention provides a method for in-vacuum process sequences and post-deposition process of a solid-state battery device. Merely by way of example, the invention has been provided with use of lithium based cells. Additionally, such batteries can be used for a variety of applications such as portable electronics (cell phones, personal digital assistants, music players, video cameras, and the like), power tools, power supplies for military use (communications, lighting, imaging and the like), power supplies for aerospace applications (power for satellites), and power supplies for vehicle applications (hybrid electric vehicles, plug-in hybrid electric vehicles, and fully electric vehicles). The design of such batteries is also applicable to cases in which the battery is not the only power supply in the system, wherein additional power is provided by a fuel cell, other battery, internal combustion (IC) engine or other combustion device, capacitor, solar cell, etc.

Common electro-chemical cells often use liquid electrolytes. Such cells are typically used in many conventional applications. Alternative techniques for manufacturing electro-chemical cells include solid state cells. Such solid state cells are generally in the experimental state, have been difficult to make, and have not been successfully produced in large scale. Although promising, solid state cells with significant capacities that can be used for the applications listed above have not been achieved due to limitations in cell structures and manufacturing techniques. These and other limitations have been described throughout the present specification and more particularly below.

Solid state batteries have been proven to have several advantages over conventional batteries using liquid electrolytes in lab settings. Safety is the foremost one. A solid state battery is intrinsically more stable than batteries based on liquid electrolyte cells, since it does not contain a liquid that causes undesirable reactions, which can result thermal runaway, and an explosion in the worst case. Solid state batteries can store more energy for the same volume or same mass compared to conventional batteries. Good cycle performance, more than 10,000 cycles, and good high temperature stability also has been reported.

Despite of these outstanding properties of solid state batteries, there are challenges to address in the future to make this type of batteries available in the market. To exploit the compactness and high energy density, packaging of such batteries should be improved. To be used in variety of applications such as consumer electronics or electric vehicle, other than the current application, large area and fast film deposition techniques at low cost should be developed. This present invention provides a method of achieving high capacity solid state batteries for the new variety of applications.

### BRIEF SUMMARY OF THE INVENTION

According to the present invention, techniques related to the manufacture of electrochemical cells are provided. More particularly, the present invention provides a device and method for fabricating a solid state thin film battery device. Merely by way of example, the invention has been provided with use of lithium based cells. Solid state batteries are generally in the experimental, or in the small scale production state, have been difficult to make, and have not been successfully produced in large scale. Although promising, solid state cells with significant capacities that can be used for the most of the applications have not been achieved due to limitations in cell structures and manufacturing techniques.

In a preferred embodiment, the present invention provides a method for manufacturing solid state batteries using an iterative set of process sequences that repeats a number of times to build multiple stacks to achieve high capacity which is greater than 0.1 mAh. The invention includes a moving a substrate in a closed loop process sequence for a number of times to build the target number of stacks based on the battery capacity specification. The moving substrates run through a plurality of processes to build a single stack by sequentially depositing a plurality of materials derived from deposition sources to form a resulting electrochemical cell overlying the substrate, the plurality of processes for a release material, a first current collector, an electrolyte layer that is capable of an electrochemical reaction with ions, a second electrode layer, a second current collector, an interlayer.

In a preferred embodiment, the present invention provides a method of following the resulting electrochemical cell overlying the release material, moving the substrate back to the start of the process sequence to form a second electrochemical cell overlying the first cell stack on the same substrate, and repeating the cell stack deposition sequence for 1 to N times until the multiple stack electrochemical batteries that have high capacity greater than 0.1 mAh.

In a preferred embodiment, the present invention provides a method of achieving high energy density greater than 50 Watt-hour per Liter by eliminating the substrate from the battery device. The method includes battery device releasing step from the substrate. Solid state batteries that typically have less than 200 micron layer thicknesses formed over flat panel substrates, such as glass, alumina, or metal substrates, have very limited energy density if the flat panel substrates are included in the packaged battery product as parasitic components. By releasing the battery device from the thick flat panel substrate, the solid state battery can achieve high energy density greater than 50 Watt-hour per Liter. The substrate for the process sequence is a flat panel from a rigid material comprised of at least one of glass, alumina, ceramic, mica, metal, plastic, barrier coated material, protected material, low diffusion material, masked or patterned material. The release material is selected from at least one of polymer, flouropolymer, monomer, oligomer, conductive material, semiconductive material, or combinations, dual function release layer, dessicant, depolymerization layer, heat lift-off material, polyimide, polydimethylsiloxane (PDMS), semi-organic molecular siloxanes, hydrophobic layer, epitaxial life-off material, amorphous flouropolymer, radiation lift-off material. The battery releasing process from the substrate comprises a process selected from a chemical dissolution, a thermal process, an irradiation process, a gravitational process, a mechanical process, an electrical process, or a laser optical process.

In a preferred embodiment, the present invention provides another method of achieving high energy density greater than 50 Watt-hour per Liter by processing on thin web substrates (0.1 μm to 100 μm) that are included as a part of battery device by minimizing the penalty on energy density. The thin web substrate is a flexible material selected from a polymer including but not limited to, polyethylene teraphtalate (PET), polyethylene naphthalate (PEN), or a metal foil including but not limited to copper, aluminum, stainless steel, nickel, and alloy foils. The invention provides a method of rolling the resulting electrochemical cell carried on the flexible substrate in a single or multiple directions for the process sequence and per deposition chamber configurations. The roll-to-roll process can be done on single or both side of the flexible substrate; double sided electrochemical cells share a single flexible substrate to further minimize the parasitic volume and mass from the substrate.

In a specific embodiment, the present invention provides a method of non-contact cooling for the flexible substrate as an example but not limited by gas injection in the proximity of the substrate throughout the process sequence. And the flexible substrate is selected from conductive materials and has insulation coating layer by either a pre-treatment with dip coating and oxidation or a vacuum deposition of insulation materials.

In a preferred embodiment, the present invention provides a method of directly depositing the solid state batteries on a component of a variety of applications such as portable electronics (cell phones, personal digital assistants, music players, video cameras, and the like), power tools, power supplies for military use (communications, lighting, imaging and the like), power supplies for aerospace applications (power for satellites), and power supplies for vehicle applications (hybrid electric vehicles, plug-in hybrid electric vehicles, and fully electric vehicles). Merely by way of example, a vacuum compatible component such as metal or plastic housing of an electronic device can be used as a platform of the deposited batteries instead of using additional substrate material. Upon completion the solid state batteries are integrated in the device component and then be assembled to the tool without any additional packaging steps. This method presents a great advantage in energy density as it can maximize the available space within the electronic device for batteries.

### BRIEF DESCRIPTION OF THE DRAWINGS

The following diagrams are merely examples, which should not unduly limit the scope of the claims herein. One of ordinary skill in the art would recognize many other variations, modifications, and alternatives. It is also understood that the examples and embodiments described herein are for illustrative purposes only and that various modifications or changes in light thereof will be suggested to persons skilled in the art and are to be included within the spirit and purview of this process and scope of the appended claims.

FIG. 1 is a simplified diagram of a thin film battery manufacturing facility layout consisting of multiple thin film deposition vacuum chambers and a loadlock, as an in-line design.

FIG. 2 is a simplified illustration of a single stack solid state battery cell according to an example of the present disclosure.

FIG. 3A is a simplified illustration of multiple stacked solid state battery cells deposited on top of a releasing layer and an substrate according to an example of the present disclosure.

FIG. 3B is a simplified illustration of a process to release multiple stack solid state battery cells from an substrate and a releasing layer according to an example of the present disclosure.

FIG. 4 is a simplified diagram of a thin film battery manufacturing plant layout of a multi-drum design configuration, called a carousel design.

FIG. 5 is a simplified diagram of a thin film battery manufacturing plant layout including several rotating units that control a moving surface, such as a conveyer belt or web, as a roll-to-roll design.

FIG. 6 is a simplified illustration of a multiple stacked solid state battery cells deposited on a thin substrate layer according to an example of the present disclosure.

FIG. 7 is a schematic representation of fabricating a multiple stacked solid state battery cells on a drum according to an example of the present disclosure.

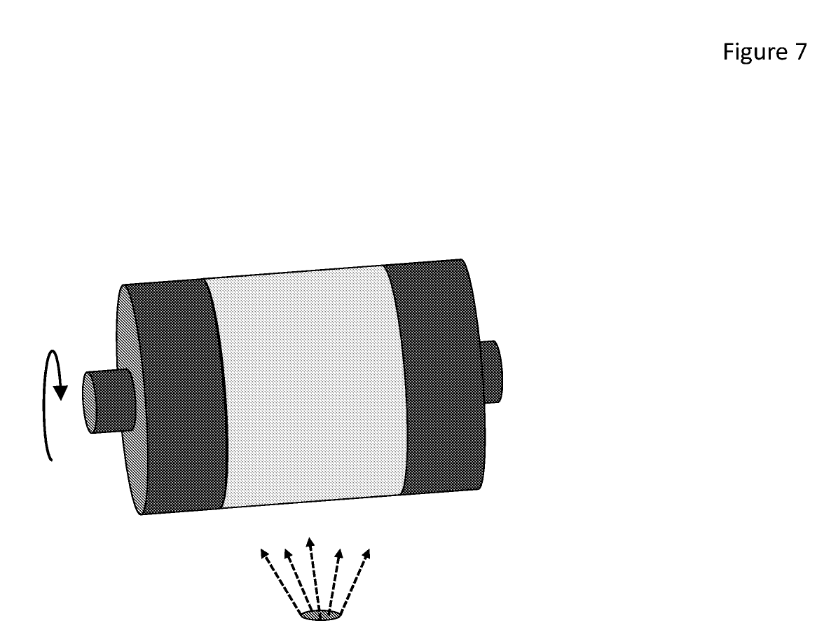

FIG. 8 is an image of deposited solid state batteries manufactured on a flat panel type substrate, a soda lime glass substrate as an example.

FIG. 9 is an image of deposited film batteries manufactured on a drum coater according to an embodiment of the present invention.

FIG. 10 is an image of deposited solid state batteries manufactured on a flexible polymer substrate on a roll-to-roll equipment.

FIG. 11 is a schematic illustration of multiple stack solid-state batteries by winding according to an example of the present disclosure.

FIG. 12 is a schematic illustration of procedure to fabricate multiple stack solid-state batteries by cutting after winding according to an example of the present disclosure.

FIG. 13 is a schematic illustration of multiple stack solid-state batteries by z-folding according to an example of the present disclosure.

FIG. 14 is a schematic illustration of procedure to fabricate multiple stack solid-state batteries by cutting after z-folding according to an example of the present disclosure.

FIG. 15 is a schematic illustration of procedure to fabricate multiple stack solid-state batteries by cutting and stacking according to an example of the present disclosure.

FIG. 16 is a schematic illustration of stacked solid state batteries by consecutive deposition processes according to an example of the present disclosure.

FIG. 17 is a schematic representation of fabrication a multiple stacked solid state battery cells on an arbitrary shape of mandrel as winding during deposition according to an example of the present disclosure.

FIG. 18 is a schematic representation of winding multiple stacked solid state battery cells on an arbitrary shape of mandrel from a deposited drum according to an example of the present disclosure.

FIG. 19 is a list of simplified illustrations of arbitrary configuration of a multiple stacked solid state battery cells according to an example of the present disclosure.

FIG. 20 illustrates a multiple stack battery device integrated on a curved surface of a handheld appliance as part of the structure.

FIG. 21 illustrates a multiple stack battery device cut to the shape of available spaces within a cylindrical shape appliance.

FIG. 22 illustrates a multiple stack battery device wound to a shape of a ring integrated around the head of a bladeless fan.

### DETAILED DESCRIPTION OF THE INVENTION

According to the present invention, techniques related to the manufacture of electrochemical cells are provided. More particularly, the present invention provides a device and method for fabricating a solid state thin film battery device. Merely by way of example, the invention has been provided with use of lithium based cells. Solid state batteries are generally in the experimental, or in the small scale production state, have been difficult to make, and have not been successfully produced in large scale. Although promising, solid state cells with significant capacities that can be used for the most of the applications have not been achieved due to limitations in cell structures and manufacturing techniques.

In a preferred embodiment, the present invention provides a method for manufacturing solid state batteries using an iterative set of process sequences that repeats a number of times to build multiple stacks to achieve high capacity which is greater than 0.1 mAh. The invention includes a moving a substrate in a closed loop process sequence for a number of times to build the target number of stacks based on the battery capacity specification. The moving substrates run through a plurality of processes to build a single stack by sequentially depositing a plurality of materials derived from deposition sources to form a resulting electrochemical cell overlying the substrate, the plurality of processes for a release material, a first current collector, an electrolyte layer that is capable of an electrochemical reaction with ions, a second electrode layer, a second current collector, an interlayer.

In a preferred embodiment, the present invention provides a method of following the resulting electrochemical cell overlying the release material, moving the substrate back to the start of the process sequence to form a second electrochemical cell overlying the first cell stack on the same substrate, and repeating the cell stack deposition sequence for 1 to N times until the multiple stack electrochemical batteries that have high capacity greater than 0.1 mAh.

In a preferred embodiment, the present invention provides a method of achieving high energy density greater than 50 Watt-hour per Liter by eliminating the substrate from the battery device. The method includes battery device releasing step from the substrate. Solid state batteries that typically have less than 200 micron layer thicknesses formed over flat panel substrates, such as glass, alumina, or metal substrates, have very limited energy density if the flat panel substrates are included in the packaged battery product as parasitic components. By releasing the battery device from the thick flat panel substrate, the solid state battery can achieve high energy density greater than 50 Watt-hour per Liter. The substrate for the process sequence is a flat panel from a rigid material comprised of at least one of glass, alumina, ceramic, mica, metal, plastic, barrier coated material, protected material, low diffusion material, masked or patterned material. The release material is selected from at least one of polymer, flouropolymer, monomer, oligomer, conductive material, semiconductive material, or combinations, dual function release layer, dessicant, depolymerization layer, heat lift-off material, polyimide, polydimethylsiloxane (PDMS), semi-organic molecular siloxanes, hydrophobic layer, epitaxial life-off material, amorphous flouropolymer, radiation lift-off material. The battery releasing process from the substrate comprises a process selected from a chemical dissolution, a thermal process, an irradiation process, a gravitational process, a mechanical process, an electrical process, or a laser optical process.

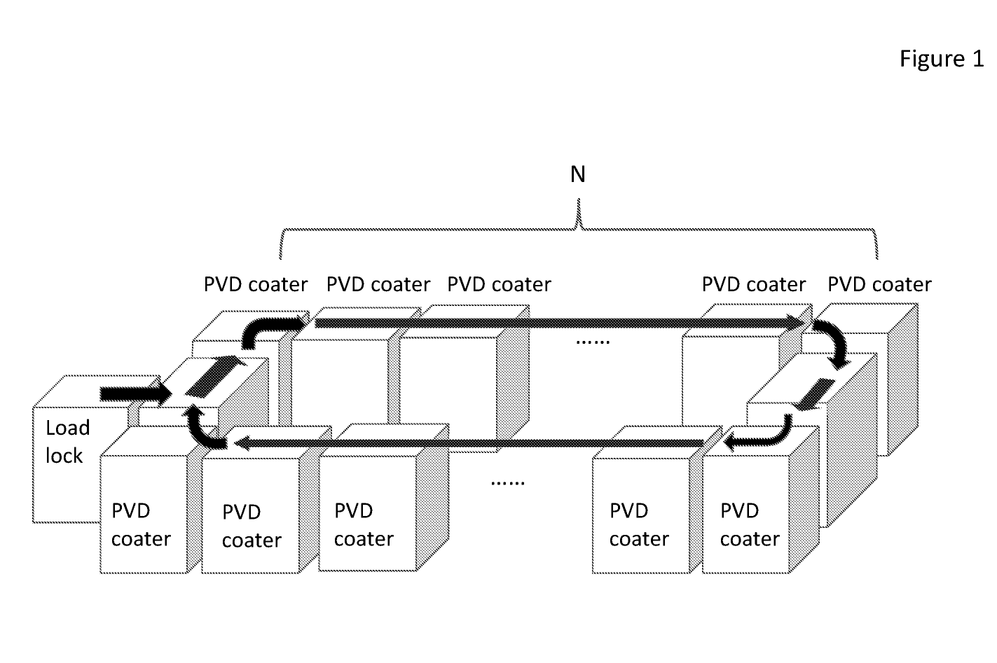

FIG. 1 is a simplified diagram of a thin film battery manufacturing facility layout according to an embodiment of the present invention. This diagram is merely an illustration and should not unduly limit the scope of the claims herein. As shown, the tool consists of multiple thin film deposition vacuum chambers and a loadlock. Substrates on which batteries are deposited move inside these chambers and the loadlock. This configuration is called an in-line design. Substrates move continuously through the chambers carried by conveyor belts or other conveying mechanisms. Chambers are connected by gates or other intermediate chambers. This process could be either a continuous or a sequence process in which substrate either moves continuously or has a certain residence or variation of transfer time in any chamber. As substrates move through chambers, battery materials are deposited onto the substrate sequentially and form batteries. After all the processes are completed for forming batteries, the substrates exit from the loadlock. One with ordinary skill in the art would be able to design multiple loadlocks or distributed loadlocks, gas gates or other transitional chambers enabling due control of pressure and composition of gasses and particles in and among the chambers. One with ordinary skill in the art would be able to design chambers of varying size and shape as needed for a variety of processes used in production of solid state battery cells.

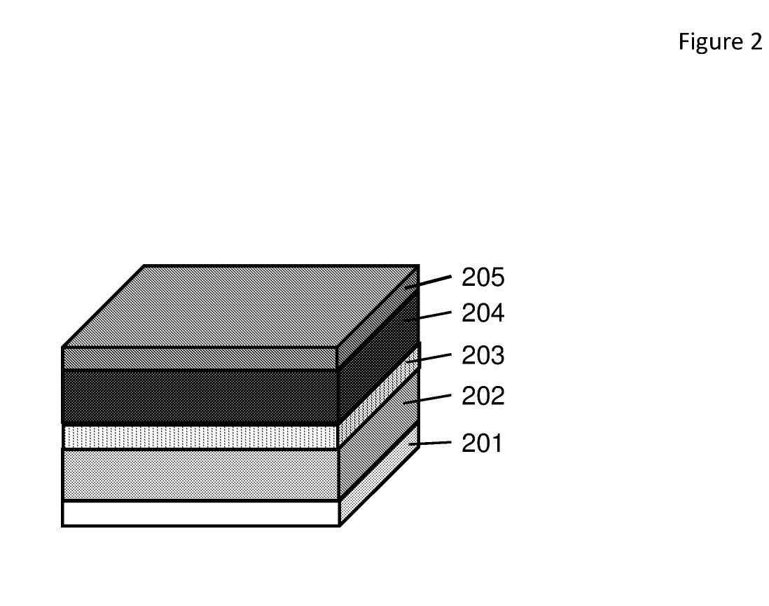

FIG. 2 is a simplified illustration of a single stack solid state battery cell according to an example of the present disclosure. 201 is a first current collector; 202 is a first electrode layer that is capable of an electrochemical reaction with ions overlying current collector; 203 is an electrolyte material overlying the cathode that is capable of ionic diffusion; 204 is a second electrode layer overlying the electrolyte; 205 is a second current collector overlying the second electrode layer.

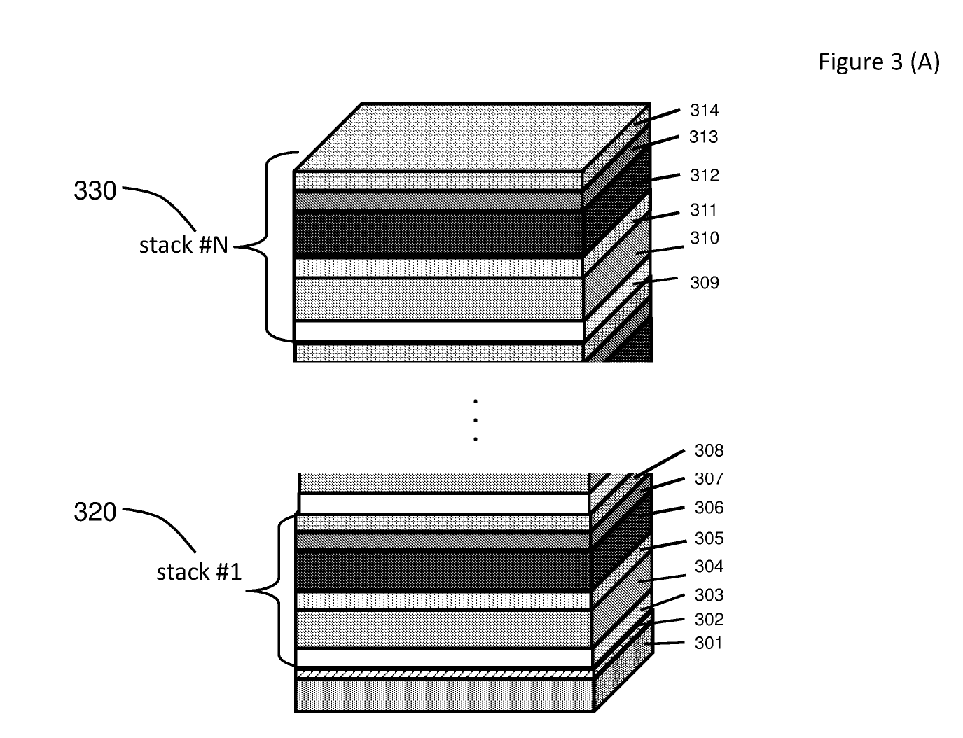

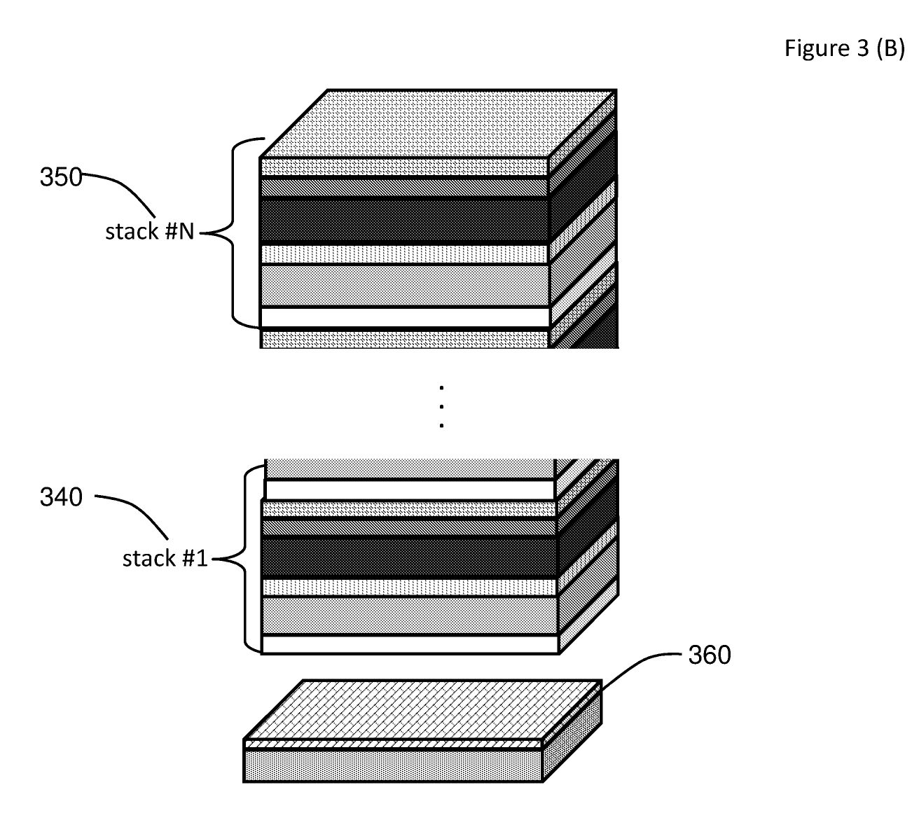

FIGS. 3A and 3B are simplified diagrams of multiple stack solid state battery cell that has release layer and releasing process step according to an example of the present disclosure. 301 is a flat panel type substrate that carries the deposited films; 302 is a release layer applied to the substrate prior to the deposition; 303 is a first current collector; 304 is a first electrode layer that is capable of an electrochemical reaction with ions overlying current collector; 305 is an electrolyte material overlying the cathode that is capable of ionic diffusion; 306 is a second electrode layer overlying the electrolyte; 307 is a second current collector overlying the second electrode layer; 308 is an interlayer overlying the second current collector that insulates between the first cell stack under this interlayer and the next cell stack; 320 is a first cell stack comprised of the five layers 303-307; 309 is a first current collector of N-th stack; 310 is a first electrode layer of N-th stack overlying current collector; 311 is an electrolyte material of N-th stack overlying the cathode; 312 is a second electrode layer of N-th stack overlying the electrolyte; 313 is a second current collector of N-th stack overlying the second electrode layer; 330 is cell stack #N comprised of the five layers 309-313 with the additional barrier layer 314; 360 is a release layer and substrate after the solid state battery is removed.

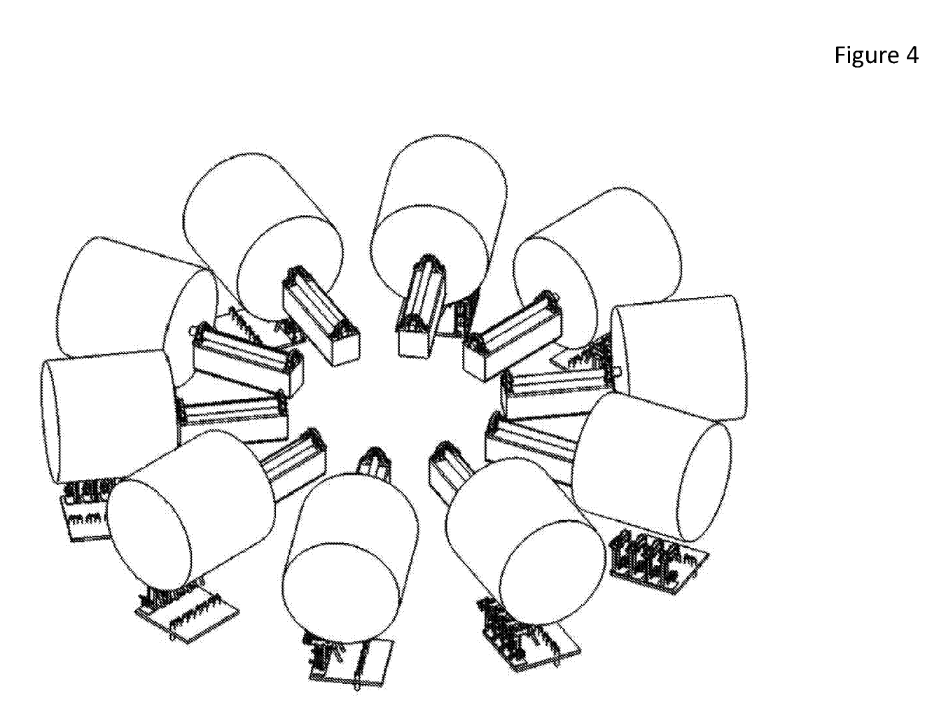

FIG. 4 is a simplified illustration of a multi-drum design configuration. It is also called carousel design. In the carousel design, a drum stays in each processing tool for a certain period until the processing task is finished and moves to the next process tool. In this design, the number of drums is equal to the number of total processing tools and all the processing tools are arranged along a circular line. There can be other variations, modifications, and alternatives. One with normal skill in the art would be able to design single drum systems with multiple sources arranged circumferentially around the drum to create multiple layers in a single chamber or to design any arbitrary combination of sources in single or multiple chambers to create specific layers on a rotating substrate. One with normal skill in the art would be able to design a rotating substrate with flat surfaces or curved surfaces, or any combination thereof, or to design a rotating surface of arbitrary shape which would serve as a mandrel for battery production. Conformally coating battery cells onto such a shape would be used to create devices with complex shapes that do not require separate packs, or packaged batteries, either singly or multiple cells. One with ordinary skill in the art would be able to design chambers of varying size and shape as needed for a variety of processes used in production of solid state battery cells.

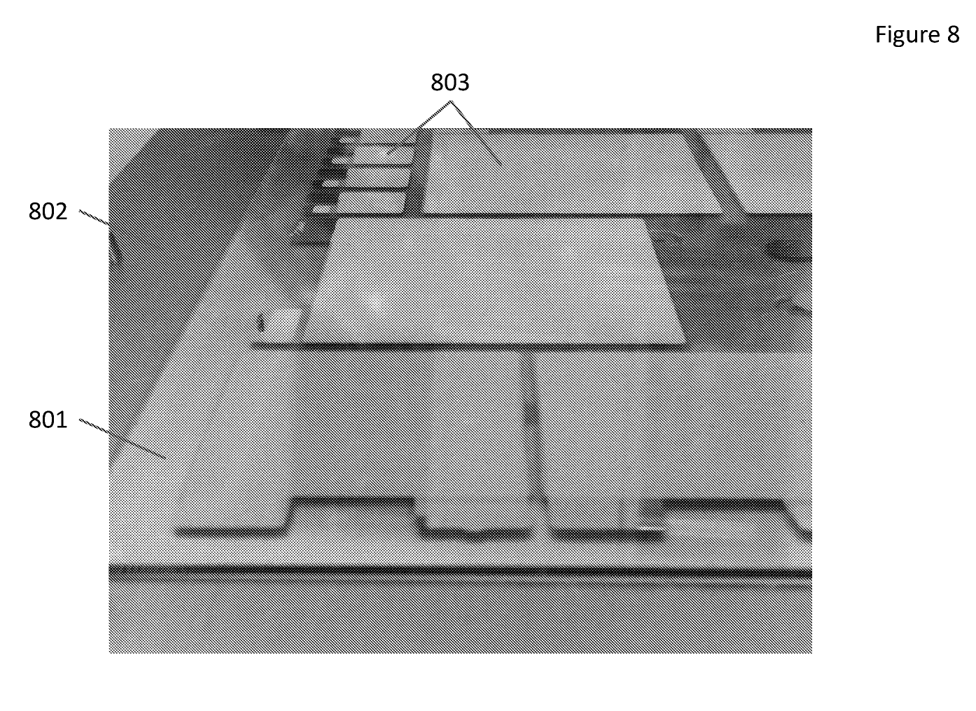

FIG. 8 is an image of deposited solid state batteries manufactured on a flat panel substrate. 801 is the soda lime glass substrate as an example of flat panel type substrates. 802 is the metal substrate tray that carries the glass substrate through the process sequence for the full layer of electrochemical cell comprised of a current collector, a first electrode, an electrolyte, a second electrode, and an interlayer. The image does not show all these layers. 803 is the top view of the solid state batteries in two different sizes.

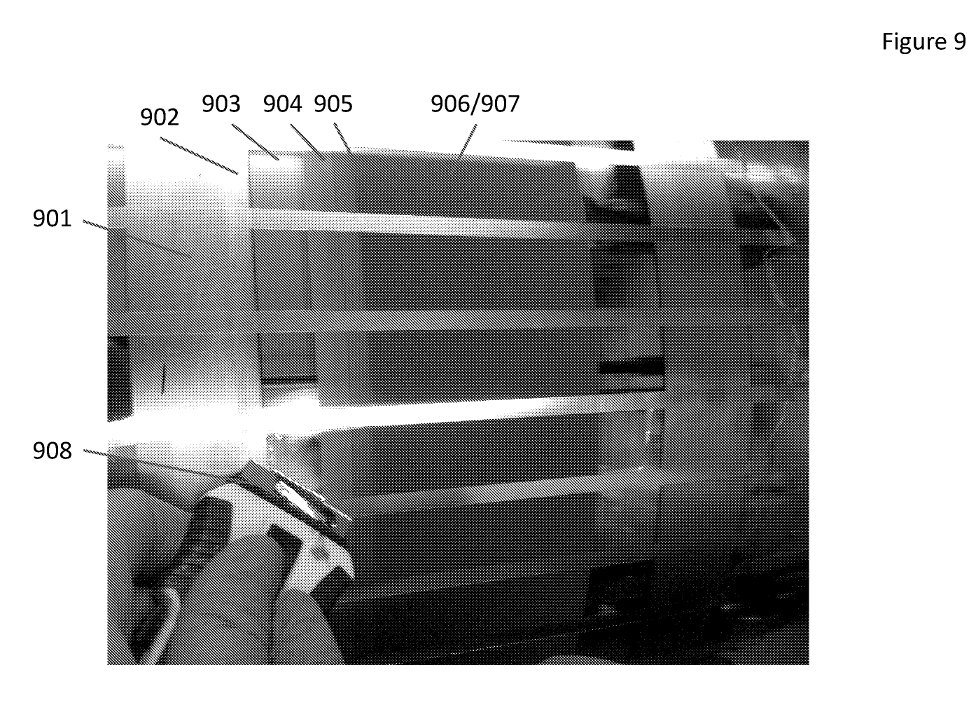

FIG. 9 is an image of deposited film batteries manufactured on a drum coater according to an embodiment of the present invention. The substrate, 901 in this example is the stainless steel surface of the drum. 902 is a release layer directly applied on the substrate prior to battery fabrication. Following the process sequence as in the present invention, comprised of a current collector 903, a first electrode (cathode) 904, an electrolyte 905, a second electrode (anode) 906, and an interlayer 907. After completion of the full stacks, the batteries are removed from the substrate by mechanical, chemical, thermal methods. In this specific example, a cutting blade 908 is used.

In a preferred embodiment, the present invention provides another method of achieving high energy density greater than 50 Watt-hour per Liter by processing on thin web substrates (0.1 μm to 100 μm) that are included as a part of battery device by minimizing the penalty on energy density. The thin web substrate is a flexible material selected from a polymer including but not limited to, polyethylene teraphtalate (PET), polyethylene naphthalate (PEN), or a metal foil including but not limited to copper, aluminum, stainless steel, nickel, and alloy foils. The invention provides a method of rolling the resulting electrochemical cell carried on the flexible substrate in a single or multiple directions for the process sequence and per deposition chamber configurations. The roll-to-roll process can be done on single or both side of the flexible substrate; double sided electrochemical cells share a single flexible substrate to further minimize the parasitic volume and mass from the substrate.

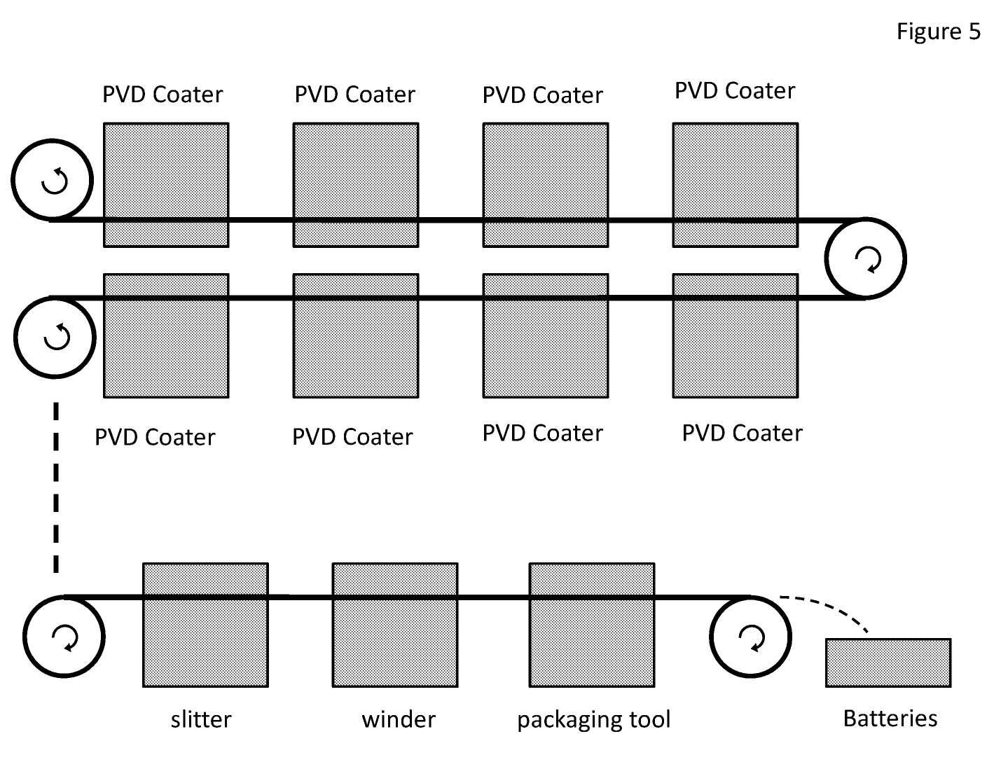

FIG. 5 is a simplified diagram of a thin film battery manufacturing plant layout according to an embodiment of the present invention. This diagram is merely an illustration and should not unduly limit the scope of the claims herein. As shown, the plant layout includes several rotating units that control a moving surface, such as a conveyer belt or web. This design can be called a roll-to-roll design. Batteries or other sources of energy can be used to drive the rotating units. The moving surface runs through several tools, each with a specified function. In a specific embodiment, the PVD Coater tools can be configured to for physical vapor deposition of one or more materials to form thin film layers for a battery device. Also, the slitter may be configured to remove excess portions of deposited layers, and the winder may be configured to coil the thin film layers. The packaging tool can encapsulate the electrochemically active materials in a sealed unit. One of ordinary skill in the art would recognize many variations, modifications, and alternatives to such a lay out, such as adding or removing chambers and adding or removing functions for individual chambers. One with ordinary skill in the art would be able to design chambers of varying size and shape as needed for a variety of processes used in production of solid state battery cells.

In many roll-to-roll coating applications, the deposited film is much thinner than the substrate itself. For example, a widely used food packaging (e.g. potato chip bags) has aluminum coating of 100 to 500 angstroms on tens to hundreds of micron polymer materials such as polyethylene terephtalate (PET). For these conventional web coatings, the substrates physically support the deposited film structure, and provide enough physical strength to be used for the purpose of the deposited thin film (aluminum seals potato chips from moisture, for example). However, the solid state battery is comprised of much thicker (ranging from 10,000 to 2,000,000 angstroms) than conventional roll-to-roll coating applications. Deposited films can provide self-support even on thin flexible substrates such as sub-micron PET or PEN that do not have enough physical strength.

Another role flexible polymer substrates in roll-to-roll coating applications is providing electrical insulation between electrochemical stacks. The polymeric dielectric substrates on which metal current collecting layers are deposited insulate the metal layers allowing very high currents to be transferred without electrical leakage. The flexible web materials may provide the similar advantages for emerging thin film battery technology. In the thin film battery application, a flexible polymer web can be used as a substrate that provides insulating properties to support roll-to-roll processed the battery layers. For form high capacity cells greater than 0.1 mAh, a number of electrochemical cell stacks need to be accumulated without electrical leakage and the flexible polymer or any other insulation material substrates can provide the necessary insulation for any method of stacking such as winding, z-folding, or cut-and-stacking presented in this invention.

The selection of a flexible substrate material in general is toward an engineered polymer with minimum thickness among the available thin material, lightweight but very durable both during processing and afterward, also often made for long lifetime and having the characteristics of being resistant to degradation by operation of the materials deposited upon it in the case of active films such as capacitors and battery cells. Alternatively, conductive materials such as thin metal foils provide another advantage over the polymer substrate as they can work as current collectors and eliminate the current collector deposition steps from the battery manufacturing.

In a specific embodiment, the present invention provides a method of non-contact cooling for the flexible substrate as an example but not limited by gas injection in the proximity of the substrate throughout the process sequence. And the flexible substrate is selected from conductive materials and has insulation coating layer by either a pre-treatment with dip coating and oxidation or a vacuum deposition of insulation materials.

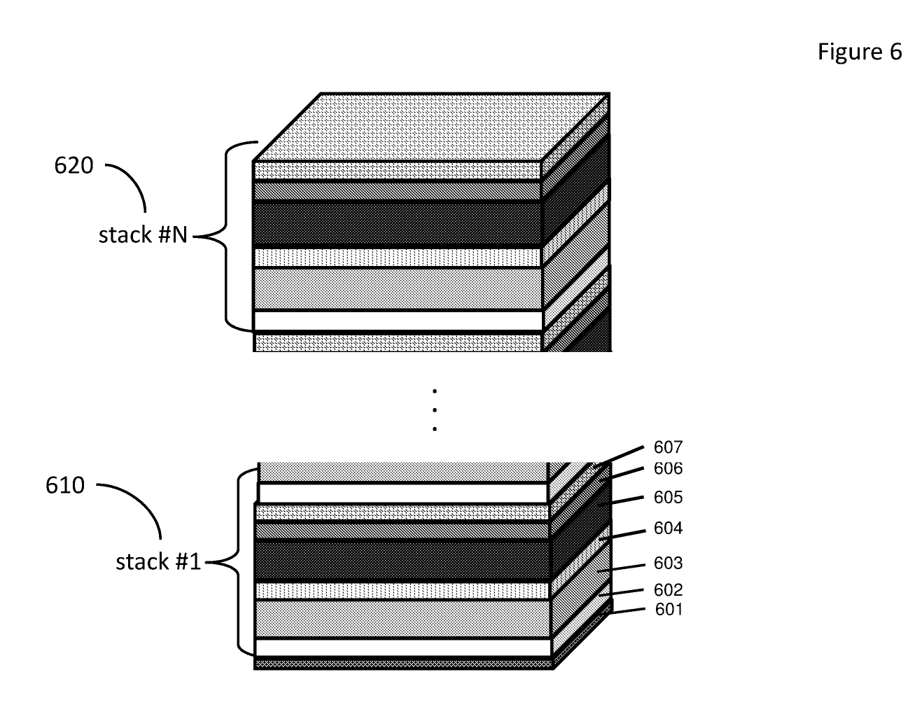

FIG. 6 is a simplified diagram of multiple stack solid state battery cell on a flexible polymer substrate according to an example of the present disclosure. 601 is a flexible polymer substrate; 602 is a first current collector on the polymer substrate; 603 is a first electrode layer that is capable of an electrochemical reaction with ions overlying current collector; 604 is an electrolyte material overlying the cathode that is capable of ionic diffusion; 605 is a second electrode layer overlying the electrolyte; 606 is a second current collector overlying the second electrode layer; 607 is an interlayer overlying the second current collector that insulates between the first cell stack under this interlayer and the next cell stack; 610 is the first cell stack, and 620 is the N-th cell stack.

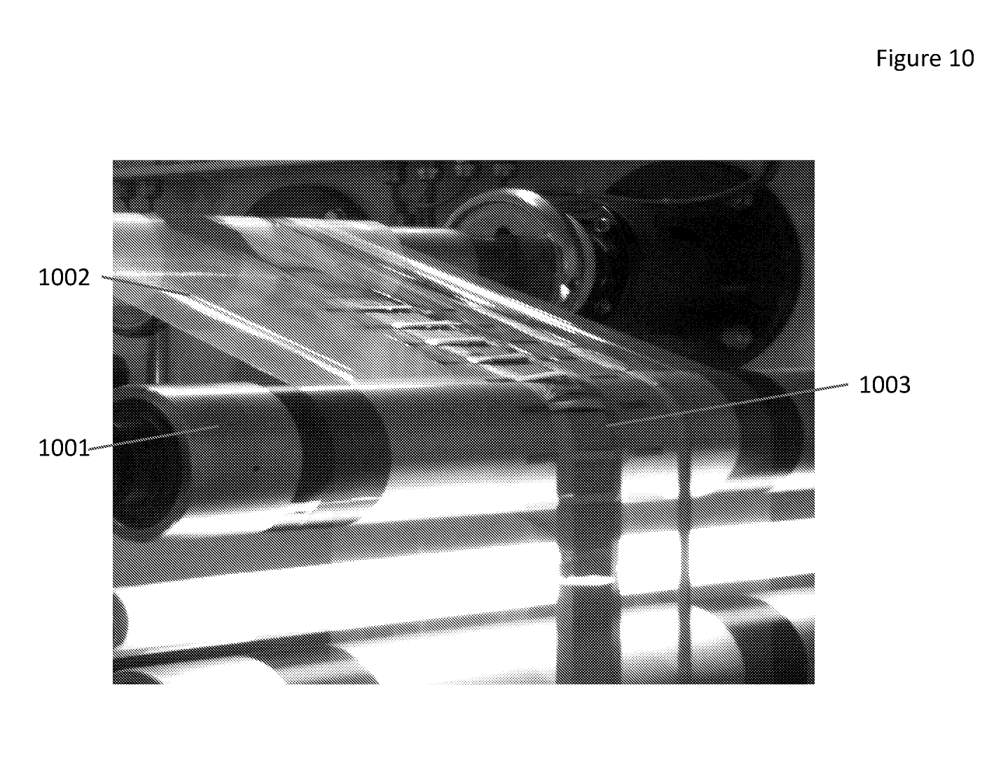

FIG. 10 is an image of deposited solid state batteries manufactured on a flexible polymer substrate on a roll-to-roll equipment. 1001 is a roller that controls the substrate motion, specifically direction and speed of the substrate per tool configuration and process. 1002 is the flexible substrate that carries the deposited layers between processes, and provides insulations among the electrochemical cell stacks; 1003 is the top view of the solid state batteries deposited on the flexible substrate traveling in a direction.

In a preferred embodiment, the present invention provides a method of directly depositing the solid state batteries on a component of a variety of applications such as portable electronics (cell phones, personal digital assistants, music players, video cameras, and the like), power tools, power supplies for military use (communications, lighting, imaging and the like), power supplies for aerospace applications (power for satellites), and power supplies for vehicle applications (hybrid electric vehicles, plug-in hybrid electric vehicles, and fully electric vehicles). Merely by way of example, a vacuum compatible component such as metal or plastic housing of an electronic device can be used as a platform of the deposited batteries instead of using additional substrate material. Upon completion the solid state batteries are integrated in the device component and then be assembled to the tool without any additional packaging steps. This method presents a great advantage in energy density as it can maximize the available space within the electronic device for batteries.

In order to show examples of certain benefits for the embodiments herein, we describe the present invention in the following example cases. Of course, these examples are merely illustrations, which should not unduly limit the scope of the claims herein. One of ordinary skill in the art would recognize other variations, modifications, and alternatives.

### Example 1

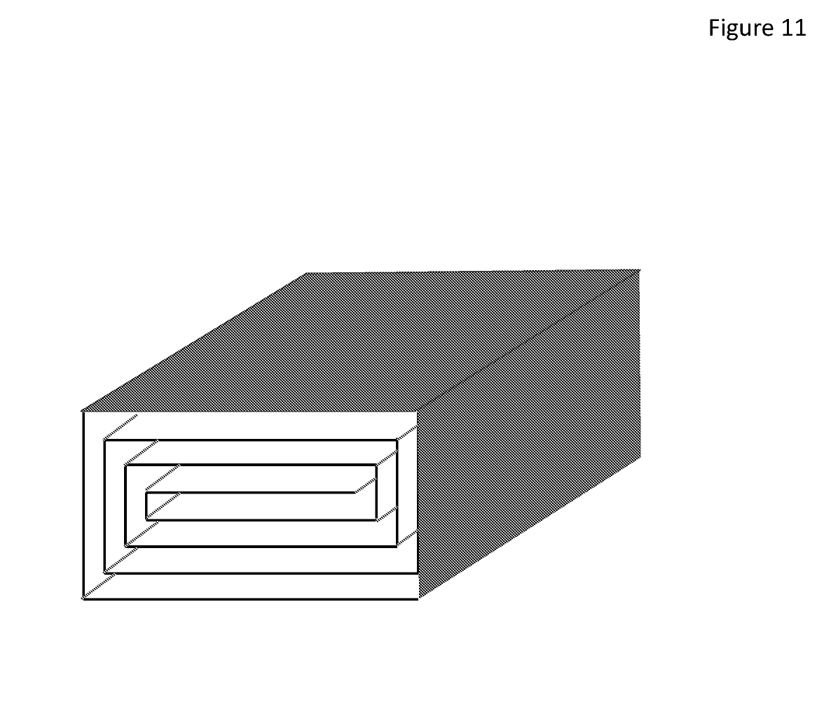

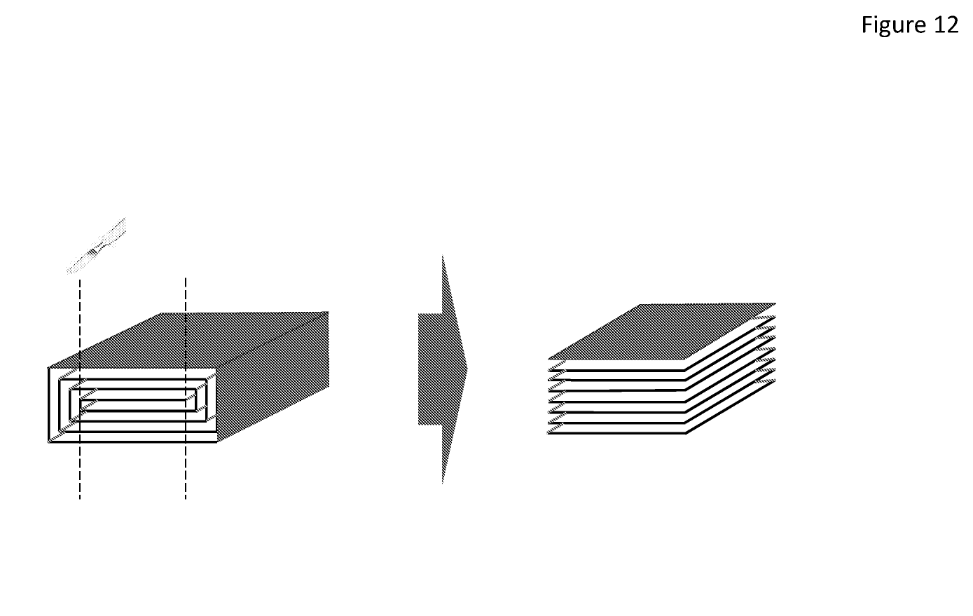

Building multiple stack solid state batteries by winding: As an example, the present invention provides a method of using a flexible material that has a thickness in the range between 0.1 and 100 μm as the substrate for the solid state batteries. The flexible material can be selected from polymer film, such as PET, PEN, or metal foils, such as copper, aluminum. The deposited layers that comprise solid state batteries on the flexible substrate, then can be wound into a cylindrical shape or wound then compressed into a prismatic shape. FIG. 11 shows the image of the wound cell as an example of the present invention. The wound cells can further be processed by cutting the round corners to maximize the energy densities as shown in FIG. 12.

### Example 2

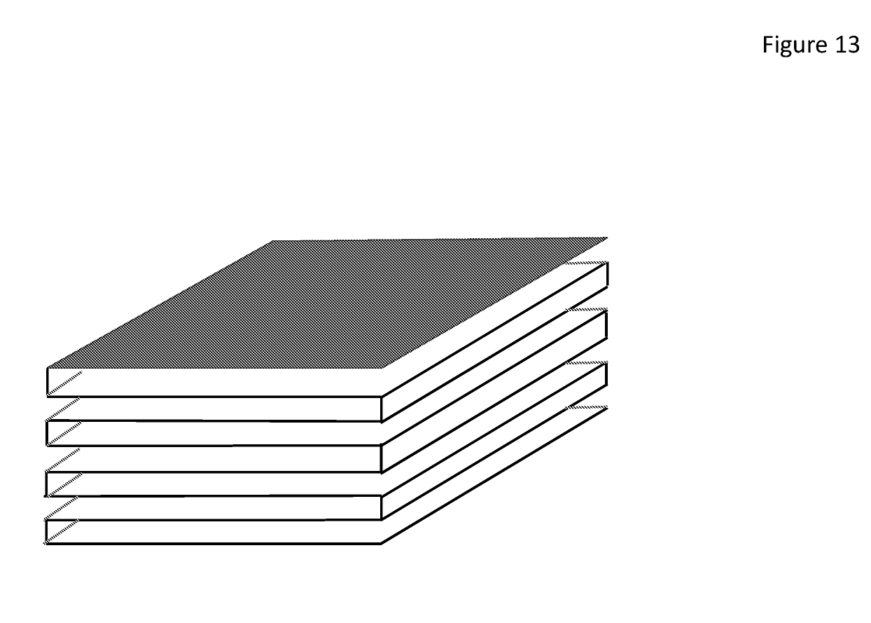

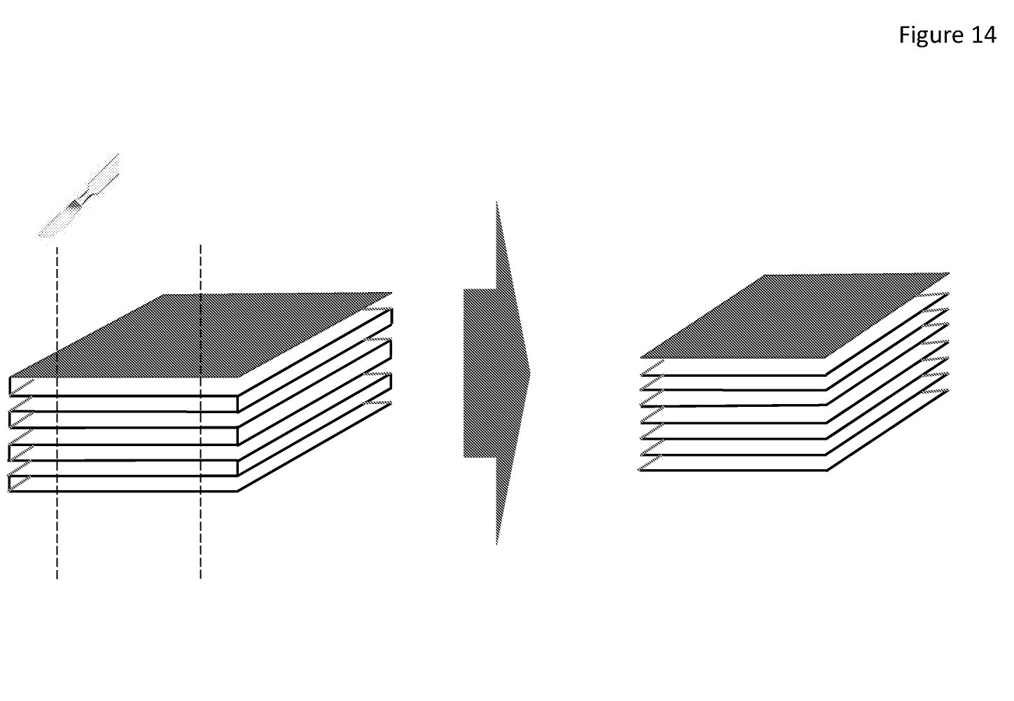

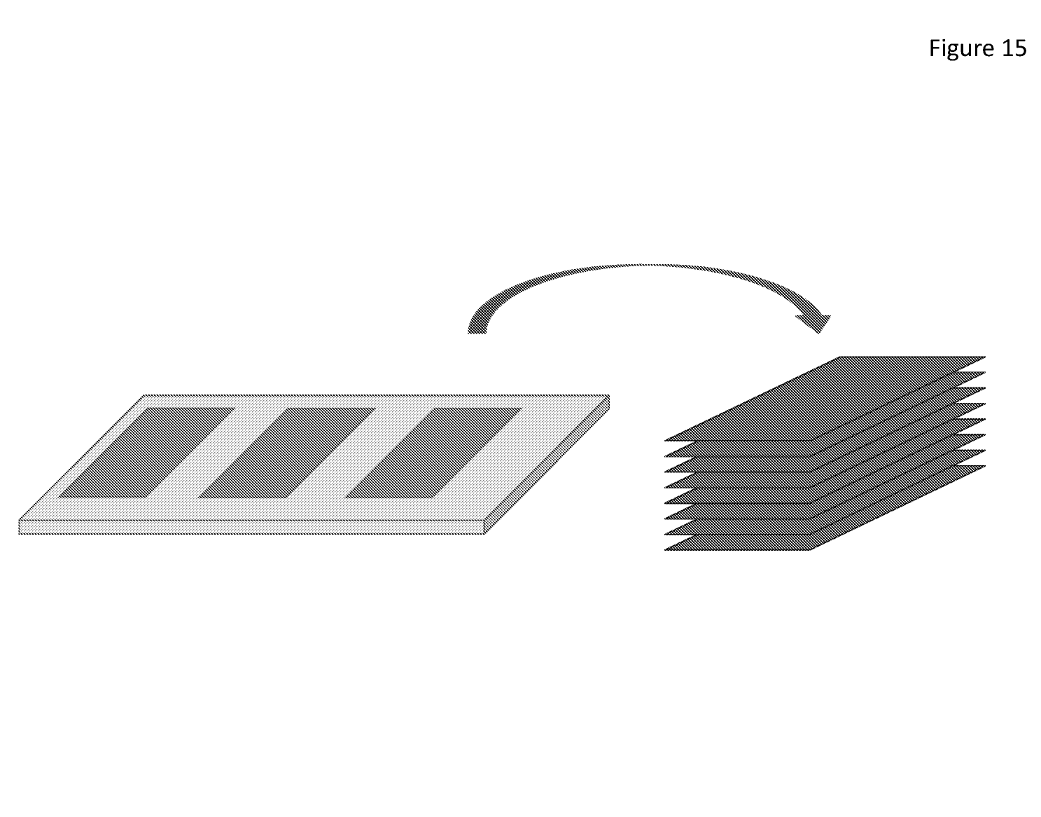

Building multiple stack solid state batteries by z-folding: As an example, the present invention provides a method of using a flexible substrate that can be a part of solid state batteries. As shown in FIG. 13, the deposited layers of solid state batteries on the flexible substrate can be stacked by z-folding. The z-folded cells can further be processed by cutting two sides of cells and terminating them to maximize the energy densities as shown in FIG. 14. By alternating the process sequence, another configuration of multistack battery can be made by cutting the individual layers and then stacking them as illustrated in FIG. 15.

### Example 3

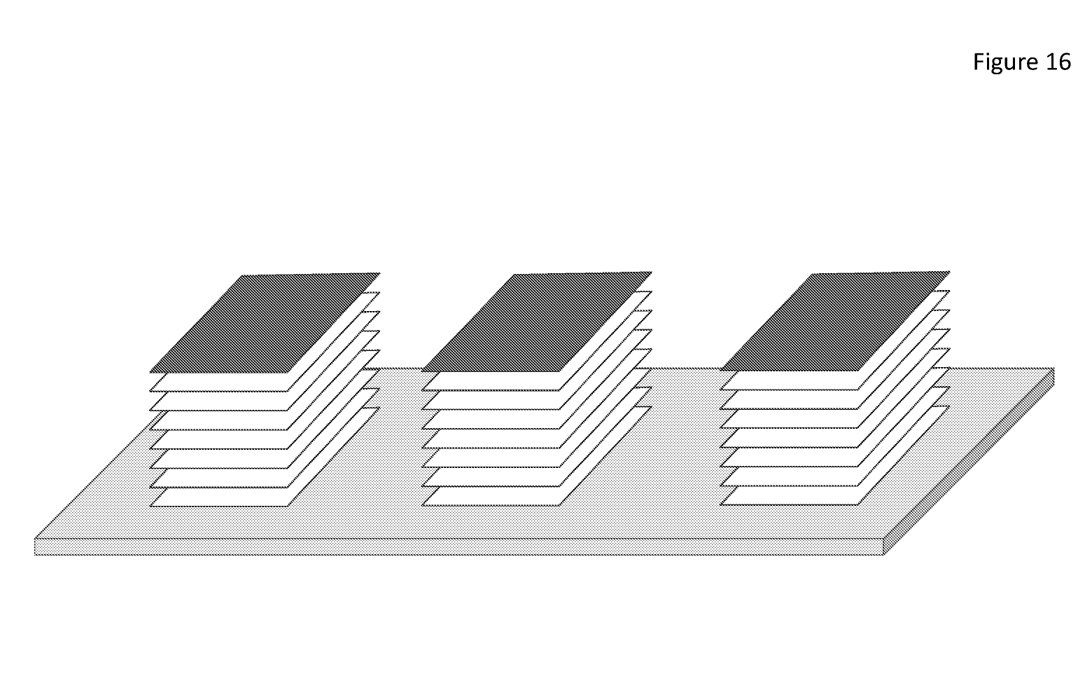

Building multiple stack solid state batteries by iterative Deposition Process: As an example, the present invention provides a method of building multiple stack solid state batteries by moving a substrate through a number of deposition processes. By repeating a sequence of processes by N times, the solid state battery device has N number of stacks as shown in the schematic diagram in FIG. 16.

### Example 4

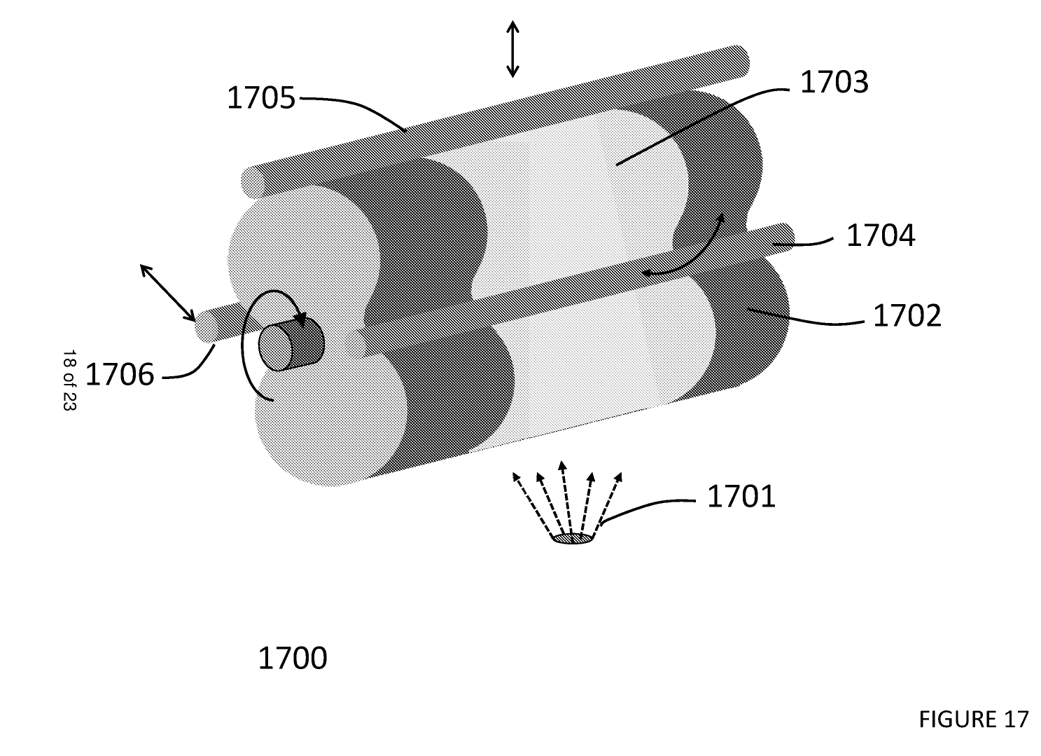

Winding solid state battery cells on arbitrary shape of mandrel, FIG. 17 shows schematically the winding solid state battery cells on mandrel 1701, and deposition means. This is as an example of deposition of multiple stack solid state battery cells with arbitrary shape of mandrel, but it is not limited to the shape illustrated here. In this example, the cross section of 8-shape can be as vacuum cleaner handle part. The vacuum cleaner handle part can be used as the substrate for solid state battery cells. In one of the specific embodiment of current invention, the multiple stacked solid state battery cells can be achieved by depositing each cell components sequentially, from first current collector, cathode, electrolyte, anode, second current collector, and insulating interlayer. This deposition sequence will be repeated 1 to N times until desired total capacity achieved. Because of the thin layer characteristics, the increased volume of the stick vacuum would be minimized compared to conventional liquid or polymer gel types of battery cells. In this example, there are needs to have push rollers as 1704, 1705 and 1706 to assist the deposition battery cells 1703 conformably stick on the mandrel. As the mandrel rotating, the push rollers would need to move along the surface so that they would not be on the way of the rotation. Furthermore, the deposition sources are located under the mandrel as an example. However, the location of the deposition source can be located in any location around the mandrel to achieve uniformity of the multiple stacked solid state battery cells. The required deposition sources will be moved into the positions when they are needed. The deposition sources can also be positioned based the shape of the mandrel. For example, the two different layer deposition sources can be position on the opposite side of the 8 shape mandrel due to wide shade shielding characteristics to minimize the deposition time.

### Example 5

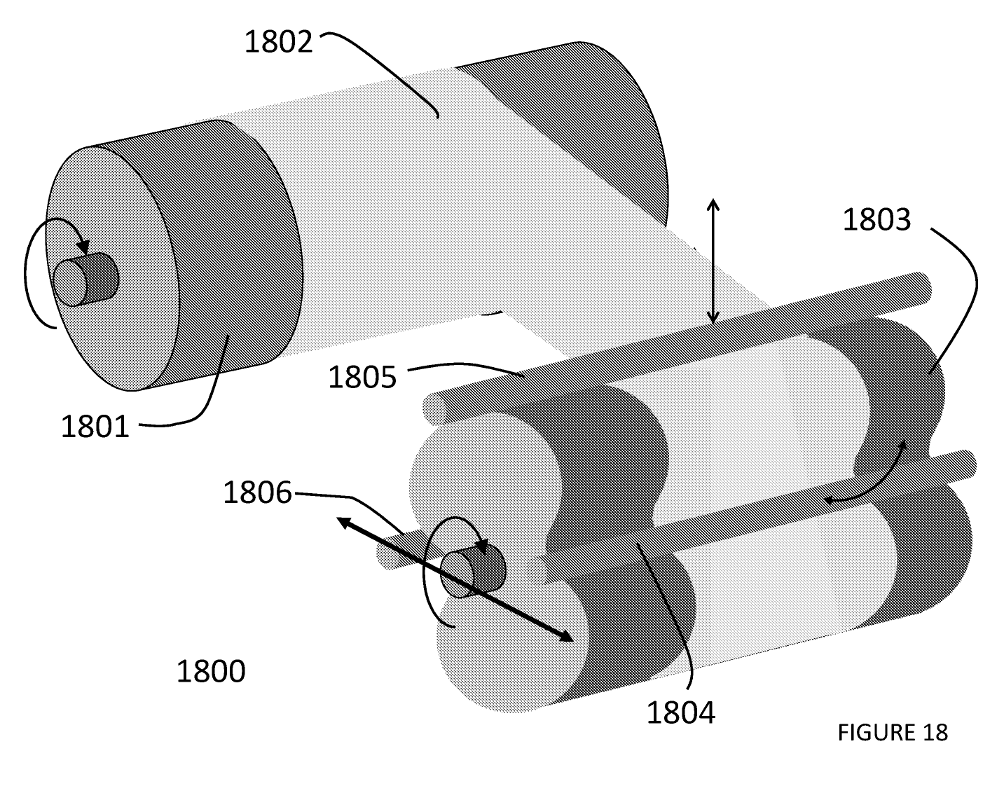

Winding on arbitrary shape of mandrel, FIG. 18 shows schematically the winding on mandrel 1803. This is as an example of deposition of multiple stack solid state battery cells with arbitrary shape of mandrel, but it is not limited to shape illustrate here. In this example, the cross section of 8 shape can be as a vacuum cleaner handle part. In one of the specific embodiment of current invention, the multiple stack solid state battery cells can be achieved by depositing each cell components sequentially on another drum or mandrel 1801, from first current collector, cathode, electrolyte, anode, second current collector, and insulating interlayer. This deposition sequence will be repeated 1 to N time until desired total capacity achieved. Once the desired total capacity achieved, rolled solid state battery cells will be move to winding station. On the winding station, the desired shape mandrel will be used to load the solid state battery cell. The deposited solid state battery cells will be unloaded from the cylindrical drum and winded to the desired shape mandrel, as in this example, 8-shape mandrel. After wounded to the 8-shape mandrel, the final packaging layer will be layered on top of the battery to provide insulation to environment. Because of the thin layer characteristics, the increased volume of the vacuum cleaner handle would be minimum compared to conventional liquid or polymer gel types of battery cells. In this example, there are needs to have push rollers as 1804, 1805 and 1806 to assist the winding battery cells 1802 conformably stick on the mandrel surface. As the mandrel rotating, the push rollers would need to move along the surface so that they would not be on the way of the rotation.

### Example 6

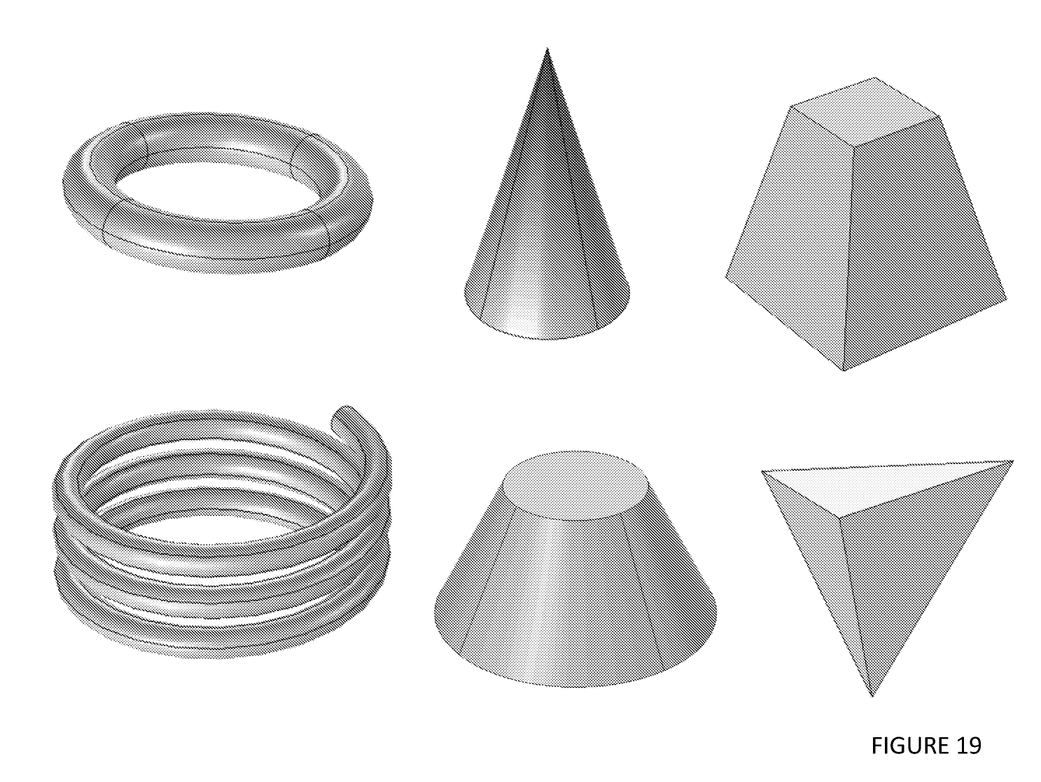

Integrating the multiple stack solid state batteries to the structural and/or decorative space of application device: The solid state batteries on a flexible substrate disclosed in this present invention can form any arbitrary shape. FIG. 19 demonstrates some of the example form factors that the flexible batteries may have, such as a torus, a coil, a circular cone, a trapezoidal cone, a tetrahedron.

### Example 7

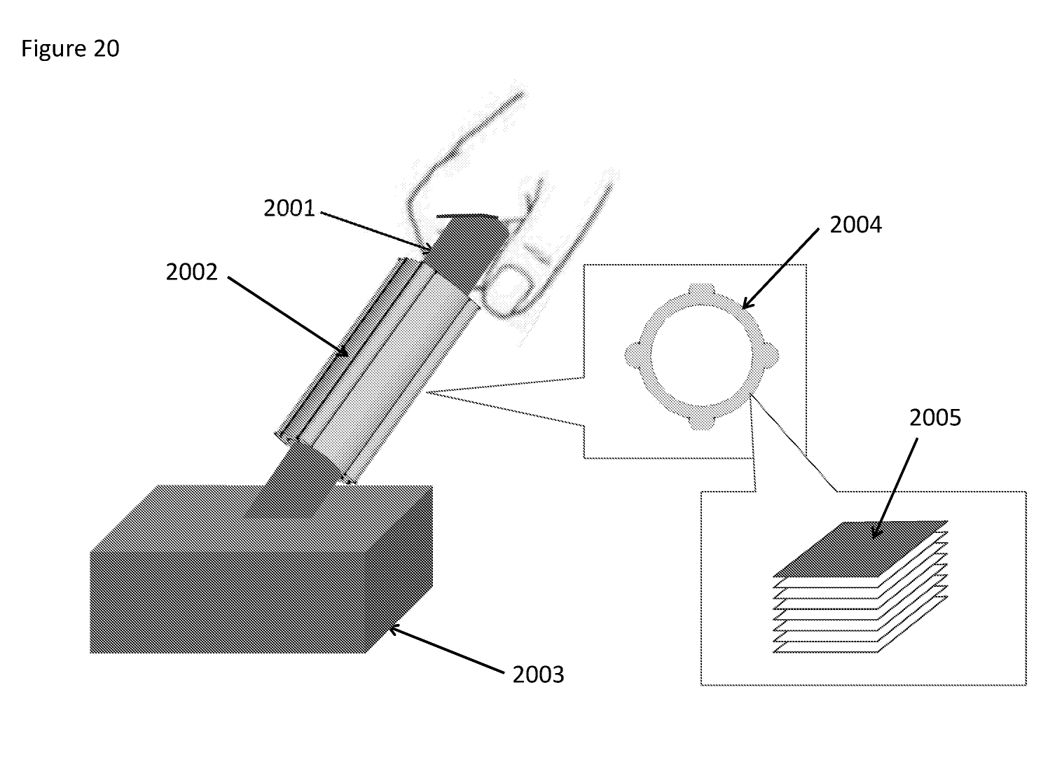

An example of forming a multiple stack battery device on an arbitrarily curved surface is shown in FIG. 20. A battery device 2002 is wound on a tubular shaped handle 2001 with arbitrary features. Typically, a battery pack is equipped with a main body of an appliance 2003, but the current invention allows another degree of freedom for design by having batteries anywhere within the appliance such that enhanced appearance, more even distribution of weights for ease of use are achieved. 2004 shows a cross section of the handle, having arbitrarily curved shape, and 2005 shows a multiple stack structure used in the battery 2002. As an example, the integration of solid state batteries to a curved surface of application device has been described in (Sastry et al. U.S. patent application Ser. No. 13/910,036), and assigned to Sakti3, Inc. of Ann Arbor, Mich., which is hereby incorporated by reference in its entirety.

### Example 8

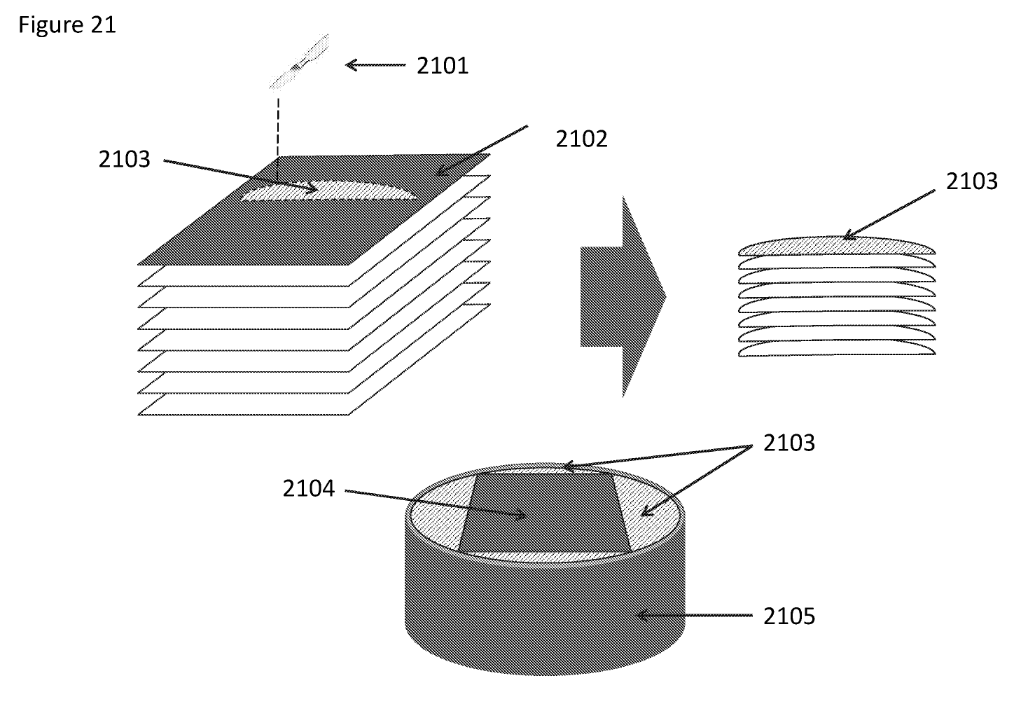

Many of the consumer electronic devices, and home appliances have cylindrical or partially round shape such as portable speaker, robotic vacuum, camera, smart thermostat, and smart door lock. However, the electronics, and conventional batteries that are typically a hexahedral shape cannot fill the space within the cylindrical housing of the appliance without leaving significant vacancies. Even conventional cylindrical shaped batteries cannot fill the space within lager diameter cylinder above the limit of packing. In FIG. 21, multiple stack solid state battery device 2102 can be cut into an arbitrary shape 2103 to completely utilize all of the spaces of any shape, enabling a more compact device. FIG. 21 shows a battery powered appliance 2105 having a cylindrical shape housing 2105 is packed with multiple stack solid state batteries 2013 of shape filling the rounded housing, leaving square space 2104 for other non-battery components. The multiple stack battery 2012 can be cut using a tool 2101 such as razor blade, diamond saw, cutting wheel, and laser.

### Example 9

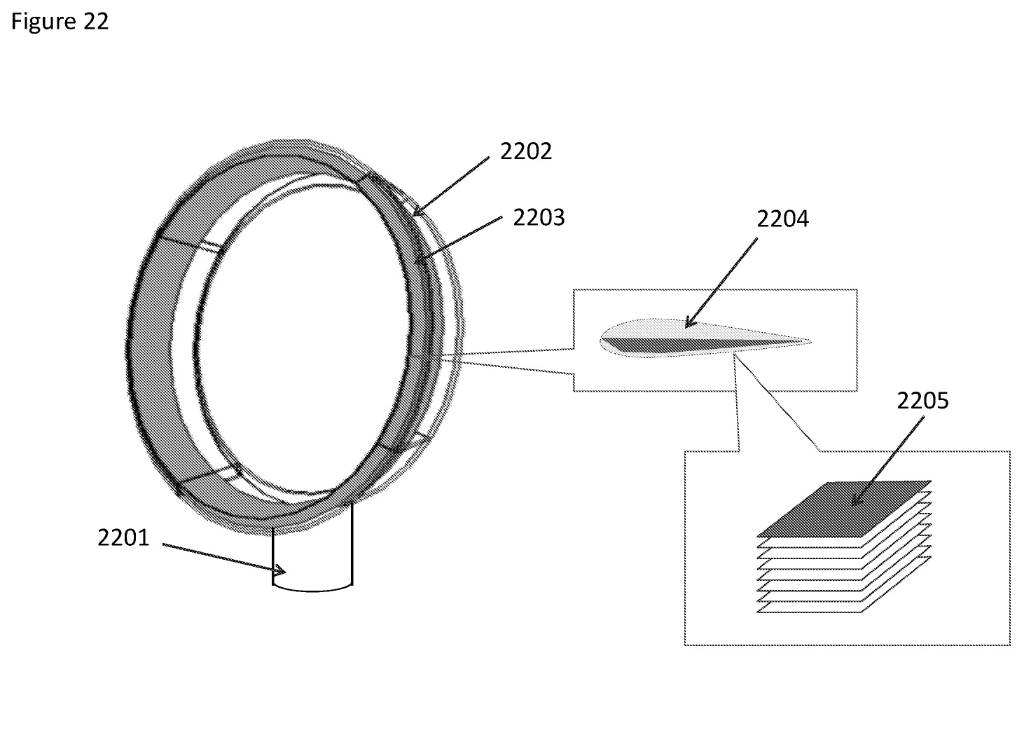

In another example as shown in FIG. 22, a multiple stack battery device 2205 is wound on a hollow core to be used within a housing 2202 of a bladeless fan or an air blower 2201 as shown in FIG. 22. Multiple stack battery 2205 integrated to the structure, for example the rim of the fan head 2204, eliminates the need of having a separate space for storage, allowing design only needed for the function of the appliance while enabling portability.

1. A method for manufacturing solid state batteries using an iterative set of process sequences that repeats a number of times to build multiple stacks to achieve high capacity which is greater than 0.1 mAh, wherein a method includes battery device releasing step from the substrate, or another method of processing on thin polymer substrates (0.1 μm to 100 μm) that are included as a part of battery device by minimizing the penalty on energy density, the process comprising:
moving a substrate in a closed loop process sequence for a number of times to build the target number of stacks based on the battery capacity specification, wherein the capacity is greater than 0.1 mAh;
performing a plurality of processes to build a single stack by sequentially depositing a plurality of materials derived from deposition sources to form a resulting electrochemical cell overlying the substrate, the plurality of processes comprising at least:
forming a release material overlying the substrate;
depositing a first current collector overlying the release material;
depositing a first electrode layer that is capable of an electrochemical reaction with ions overlying current collector in the deposition chamber;
depositing an electrolyte material overlying the cathode that is capable of ionic diffusion, the electrolyte material having an electrical conductivity and being a solid state material;
depositing a second electrode layer overlying the electrolyte material;
depositing a second current collector overlying the second electrode layer;
depositing an interlayer overlying the second current collector;
following the resulting electrochemical cell overlying the release material, moving the substrate back to the start of the process sequence to form a second electrochemical cell overlying the first cell stack on the same substrate;
repeating the cell stack deposition sequence for 1 to N times until the multiple stack electrochemical batteries that have high capacity greater than 0.1 mAh;
forming the high capacity battery by stacking the combination of the substrate and the deposited single electrochemical cell stack until the multiple stack electrochemical batteries meet the targeted capacity;
causing removal of the resulting electrochemical cell from the release material to detach the substrate from the resulting electrochemical cell.

2. The method of claim 1, wherein the substrate for the process sequence is a flat panel from a rigid material comprised of at least one of glass, alumina, ceramic, mica, metal, plastic, barrier coated material, protected material, low diffusion material, masked or patterned material.

3. The method of claim 1, wherein the release material is selected from at least one of polymer, flouropolymer, monomer, oligomer, conductive material, semiconductive material, or combinations, dual function release layer, dessicant, depolymerization layer, heat lift-off material, polyimide, polydimethylsiloxane (PDMS), semi-organic molecular siloxanes, hydrophobic layer, epitaxial life-off material, amorphous flouropolymer, radiation lift-off material.

4. The method of claim 1, wherein the battery releasing process from the substrate comprises a process selected from a chemical dissolution, a thermal process, an irradiation process, a gravitational process, a mechanical process, an electrical process, or a laser optical process.

5. The method of claim 1, wherein the substrate is a flexible material selected from a polymer including but not limited to, polyethylene teraphtalate (PET), polyethylene naphthalate (PEN), or a metal foil including but not limited to copper, aluminum, stainless steel, nickel, and alloy foils.

6. The method of claim 1, further comprising rolling the resulting electrochemical cell carried on the flexible substrate in a single or multiple directions for the process sequence and per deposition chamber configurations.

7. The method of claim 1, wherein the deposition process sequences are done on both side of the flexible substrate; where the top and bottom multiple stack electrochemical cells share a single flexible substrate to minimize the parasitic volume and mass from the substrate.

8. The method of claim 1, wherein the flexible substrate has non-contact cooling by gas injection as an example but not limited to in the proximity of the substrate throughout the process sequence.

9. The method of claim 1, wherein the flexible substrate is selected from conductive materials and has insulation coating layer by either a pre-treatment with dip coating and oxidation or a vacuum deposition of insulation materials.

10. The method of claim 1, wherein the solid state batteries are directly deposited on the components of a variety of applications such as portable electronics (cell phones, personal digital assistants, music players, video cameras, and the like), power tools, power supplies for military use (communications, lighting, imaging and the like), power supplies for aerospace applications (power for satellites), and power supplies for vehicle applications (hybrid electric vehicles, plug-in hybrid electric vehicles, and fully electric vehicles).

11. A method of fabricating a thin film solid state battery device, the method comprising:
forming a film by depositing electrode materials using a low temperature process on a polymeric substrate;
forming a multiple stack battery characterized by a capacity greater than 0.1 mAh by winding, z-folding, stacking precut films, or directly depositing multiple layers on an area less than 1 m²;
forming a multiple stack battery of uniform thickness including a substrate, ranging from 1.5 μm to 500 μm each stack and curvature by cutting boundaries of wound, or z-folded battery to achieve higher energy density by eliminating curves, and to prevent stress concentration at corners which are frequent failure locations.

12. The method of claim 11, wherein the multiple stack battery device is formed on a flat or developable surface such as cylinder, cone, or wave surface of any curvature by winding, folding, stacking the deposited film or directly depositing layers, and on a non-developable surface by directly depositing layers.

13. A method of fabricating a thin film solid state battery device, the method comprising:
forming a film by depositing electrode materials using a low temperature process on a polymeric substrate;
forming the multiple stack battery device within a footprint of an arbitrary shape by cutting the battery including the polymeric substrate to conform to a battery powered appliance.

14. The method of claim 13, wherein the multiple stack battery device is formed by cutting a tool such as razor blade, diamond saw, cutting wheel, and laser.

15. The method of claim 13, wherein the polymeric substrate includes polyethylene terephthalate, polyethylene naphthalate, polyimide, and acrylates, the thickness ranging from 0.1 μm to 100 μm.

16. The apparatus of claim 13, further comprising an appliance coupled to the plurality of battery cells, whereupon the application is selected from at least one of or more of at least a smartphone, a cell phones, personal digital assistants, radio players, music players, video cameras, tablet and laptop computers, military communications, military lighting, military imaging, satellite, aero-plane, satellites, micro air vehicles, hybrid electric vehicles, plug-in hybrid electric vehicles, fully electric vehicles, electric scooter, underwater vehicle, boat, ship, electric garden tractor, and electric ride on garden device, unmanned aero drone, unmanned aero-plane, an RC car, robotic toys, robotic vacuum cleaner, robotic garden tools, robotic construction utility, robotic alert system, robotic aging care unit, robotic kid care unit, electric drill, electric mower, electric vacuum cleaner, electric metal working grinder, electric heat gun, electric press expansion tool, electric saw and cutters, electric sander and polisher, electric shear and nibbler, electric routers, an electric tooth brush, an electric hair dryer, an electric hand dryer, a global positioning system (GPS) device, a laser rangefinder, a flashlight, an electric street lighting, standby power supply, uninterrupted power supplies, and other portable and stationary electronic devices.
